(19) United States
(12) Patent Application Publication
(10) Pub. No.: US 2009/0217891 A1
(43) Pub. Date: Sep. 3, 2009

(54) RECIPROCATING PISTON MACHINE

(75) Inventors: Wayne Stuart Alexander, Christchurch (NZ); James Stuart Morris, Christchurch (NZ)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Shed Engineering Limited, Christchurch (NZ)

(21) Appl. No.: 12/097,507

(22) PCT Filed: Dec. 14, 2006
(86) PCT No.: PCT/NZ2006/000323

§ 371 Date: Feb. 20, 2009

(30) Foreign Application Priority Data
Dec. 14, 2005 (NZ) 540740

(51) Int. Cl. F02B 75/16; F01B 9/02; F02B 75/32; F16J 9/12

(52) U.S. Cl. 123/66; 92/140; 123/197.4; 277/467

(57) ABSTRACT

A two-stroke engine (1) including, an engine block (2) having a cylinder (3), a double-ended piston (4) received for reciprocation in the cylinder (3), the piston (4) comprising a body having first and second opposing ends (7, 9), the first end (7) forming a wall of the combustion chamber (8), the second end (9) forming a wall of a pre-compression chamber (10), the piston (4) including a piston opening (11) between the first and second ends (7, 9); at least one passage extending from the pre-compression chamber (10) to the combustion chamber (8) for charging the combustion chamber(8); a connecting rod (6) operatively connecting the piston (4) to a crankshaft (5), and characterised in that the piston opening (11 ) encloses the connecting rod (6) and the crankshaft (5) protrudes through the piston opening (11).

### TECHNICAL FIELD

The invention relates generally to reciprocating piston machines and has particular application to internal combustion engines and especially to reciprocating piston two-stroke engines driving a crankshaft through a connecting rod.

### BACKGROUND ART

Two-stroke engines have a number of advantages compared to the more common four-stroke engines, and in order that these may be realised much research has been directed to solving some of the drawbacks associated with two-stroke engines. Inefficiency and pollution are a particular drawback associated with the conventional crankcase scavenged two-stroke engine where the air/fuel and oil mix interact with the base engine components such as the crankshaft, connecting rod, bearings and piston for example. As the output characteristics of two-stroke engine are determined largely by the charging efficiency this has also received considerable attention. While performance improvements have been achieved which address these issues, these have been at the expense of the simplicity and low cost of the conventional piston valve inlet port engine. For example, the provision of a scavenging chamber separate from the crankcase and charged by a blower avoids introducing oil into the induction air, thereby reducing pollution. This design also increases scavenging and charging efficiency, but at a cost which is disadvantageous on smaller engines such as may be used for powering portable equipment or smaller vehicles.

GB 2 183 731 describes an engine with a double-ended piston defining opposing working chambers, wherein the crankshaft axis extends transversely through a central part of the piston. However there is no description of how the working chambers may cooperate to provide a two-stroke engine. Moreover there is no teaching that a connecting rod may be enclosed in the piston or of how a sealed crankcase may be obtained with this arrangement of the connecting rod and crankshaft.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a two-stroke engine including:

an engine block having a cylinder;

a double-ended piston received for reciprocation in the cylinder, the piston comprising a body having first and second opposing ends, the first end forming a wall of the combustion chamber, the second end forming a wall of a pre-compression chamber, the piston including a piston opening between the first and second ends;

at least one passage extending from the pre-compression chamber to the combustion chamber for charging the combustion chamber;

a connecting rod operatively connecting the piston to a crankshaft, and characterised in that

the piston opening encloses the connecting rod and the crankshaft protrudes through the piston opening.

The piston opening extends between opposing mouth portions in the sides of the piston, the crankshaft protruding through both mouth portions. In this manner a compact engine is achieved, especially where a bore dimension exceeds the stroke.

The piston opening is preferably sealed, with a piston opening seal extending around each of the mouth portions for engagement with the cylinder wall. The piston opening may thus form a sealed crankcase which may be filled with oil for lubrication of the base engine components enclosed therein. This of course advantageously avoids the need for introducing lubricating oil into the induction air.

The piston may have generally arcuate or cylindrical side faces. Preferably, however, the cylinder is non-cylindrical and the mouth portions are formed in opposing lateral faces which are substantially planar and parallel with the axis of reciprocation of the piston. These flat faces allow an economical and reliable seal to be provided around the mouth portions.

It will be understood that, for economy, the piston may be formed from an extruded section with the two flat faces extending generally perpendicular to the axis of the extrusion.

In a preferred embodiment the piston has four substantially planar lateral faces. This design allows the engine block to also be formed from an extruded section.

According to another aspect of the present invention there is provided a piston seal assembly for sealing between a piston and a cylinder wall, the side surfaces of the piston having first and second piston faces meeting at an intersection, the cylinder wall having corresponding first and second cylinder wall faces, the seal assembly including:

first and second seal portions adapted to be received in a groove in the piston for engagement with the first and second cylinder wall faces respectively, adjacent ends of the seal portions being aligned generally with the intersection,

a seal wedge adapted to be received in the groove between the adjacent ends of the seal portions for abutting cooperating end faces of the adjacent ends, and

resilient means for biasing the seal wedge outward toward the cylinder wall, thereby pressing the first and second seal portions against the cylinder wall.

The resilient means is preferably at least one spring. By way of example, a piston with four substantially planar lateral faces would have four seal portions, each engaging a separate side of the cylinder wall, with four seal wedges—one at the intersection of each seal portion. In a preferred embodiment the groove is annular and a substantially annular spring is received in the groove and acts upon each of the seal wedges. It will be understood that this piston seal can be used with a piston with a varying number of straight or curved sides. This arrangement provides a continuous seal around the periphery of the piston, which is maintained as the working surfaces wear and which also allows the seal portions and seal wedges to be held firmly against the cylinder walls under the pressure generated when the working space adjacent the piston is pressurised.

In the preferred embodiment one seal assembly as described above is received in a circumferential groove in the piston adjacent the first end, but a seal assembly may also be provided at the second end. The shape of the second end of the piston preferably substantially conforms to the opposing wall of the pre-compression chamber, thereby providing a minimum clearance volume for good forced induction.

In still another aspect the present invention provides a piston machine, especially an engine, including:

a block having a cylinder;

a double-ended piston received for reciprocation in the cylinder, the piston comprising a body having first and second opposing ends forming walls of respective chambers, the piston including a piston opening between the first and second ends;

a connecting rod operatively connecting the piston to a crankshaft, and characterised in that

the piston opening encloses the connecting rod and the piston opening extends between opposing mouth portions in the sides of the piston, the crankshaft protruding through both mouth portions, with a seal extending around each of the mouth portions for engagement with the cylinder wall.

This arrangement also has the advantage that the piston opening in the piston forms a sealed crankcase. Such a machine is compact and may, for example, be a pump. It will be understood that a pump variant would require suitable ports, valves, piston sealing etc.

### BRIEF DESCRIPTION OF DRAWINGS

Further aspects of the present invention will become apparent from the following description which is given by way of example only and with reference to the accompanying drawings in which:

FIG. 1 is an end view of the engine of the present invention;

FIG. 2 is an exploded view of the engine of FIG. 1, and

FIG. 3 is a plan view of a piston seal for the engine of FIG. 1.

### BEST MODES FOR CARRYING OUT THE INVENTION

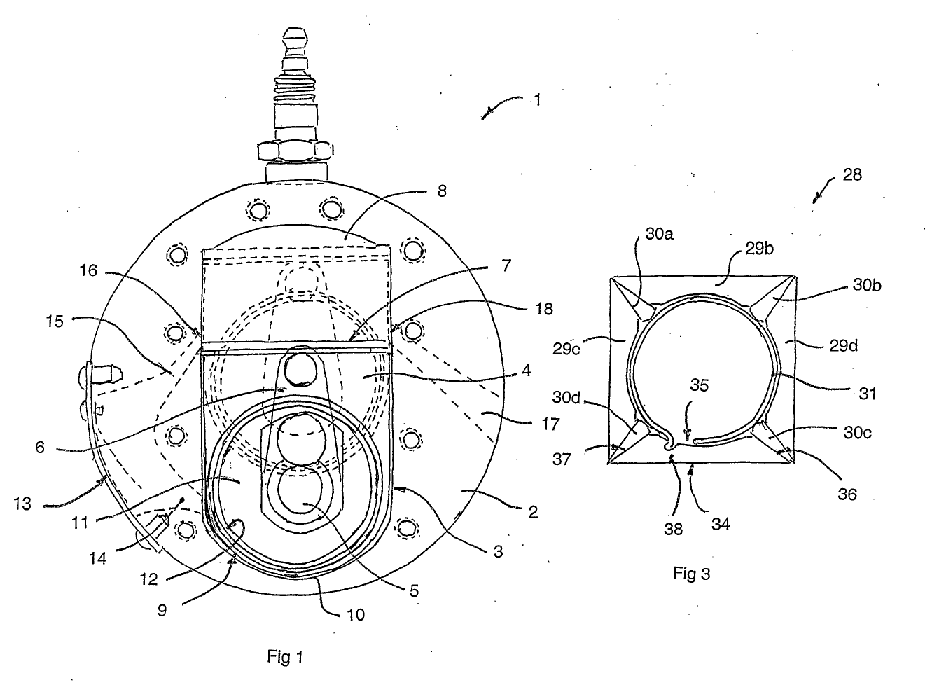

Referring to FIG. 1, a two-stroke petrol engine 1 according to a preferred embodiment of the present invention includes an engine block 2 having a cylinder 3 which holds a double-ended piston 4. The piston 4 is fixed to a crankshaft 5 by a connecting rod 6 and is shown at bottom dead centre (and at top dead centre in dashed outline).

The piston 4 has a first end 7 forming a wall of the combustion chamber 8. The second end 9 forms a wall of a pre-compression chamber 10. A piston opening 11 extend between the first and second ends 7, 9 and between opposing circular mouth portions 12 in the sides of the piston 4, through which, the crankshaft 5 protrudes. The con rod 6 is enclosed in the piston opening 11.

A reed type check valve 13 controls the flow of air/fuel through the induction passage 14 into the pre-compression chamber 10. A transfer passage 15 connects the pre-compression chamber 10 to the combustion chamber 8 through inlet port 16 in the cylinder wall. Exhaust gases pass from exhaust port 19 through exhaust passage 17. It will be understood that the porting, piston valving, pre-compression chamber valving etc are merely examples of how these functions may be performed.

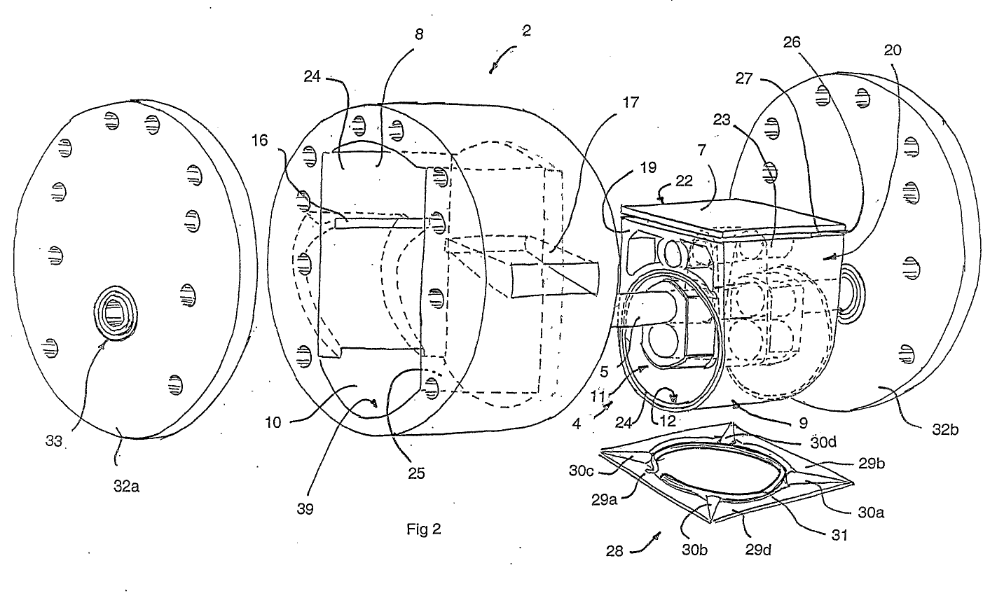

As best seen in FIG. 2, the piston 4 is square in cross-section with four substantially planar lateral faces 19-23 which extend parallel with the axis of reciprocation of the piston and intersect along four edges. The faces 19-23 include a pair of opposing lateral faces 19, 20 in which the mouth portions 12 are formed. The first end 7 is substantially planar and the second end 9 is semi-cylindrical joining the faces 22, 23 tangentially. The wall 39 of the pre-compression chamber 10 is also semi-cylindrical to conform to the second end 9, providing a minimum clearance volume.

A piston opening seal 24 extends around each of the mouth portions 12 for engagement with the planar surfaces 24, 25 of the cylinder wall adjacent faces 19, 20. The piston opening 11 thereby forms a sealed crankcase which may be filled with lubricating oil.

Adjacent the first end 7 a seal groove 26 extends in the lateral faces 19-23 and has an inner annular face 27. A piston seal assembly 28, described further with respect to FIG. 3, is received in the groove 26 and includes four seal portions 29a-29d, four seal wedges 30a-30d and an annular spring 31.

From the illustrations it will be clear that the engine block 2 and piston 4 could be economically manufactured from extruded sections having long axes generally parallel to the axis of the crankshaft 5. The side plates 32a, 32b abut the lateral faces 19, 20 of the piston 4 and have circular piston openings 33 thorough which the crankshaft 5 extends.

Referring to FIG. 3, in the piston seal assembly 28 each of the seal portions 29a-29d has an arcuate inner edge 35, a straight outer edge 34 and opposing end faces 36, 37 joining the outer edge 34 at an acute angle. The seal wedges 30a-30d abut the adjacent end faces 36, 37 and have an acute wedge angle. Resilient means in the form of annular spring 31 is received in the groove 26 with one end received in a notch 38 to hold it in place. The spring 31 tends to open and acts upon each of the seal wedges 30a-30d thereby maintaining contact between the outer edge 34 and the corresponding cylinder walls on either the engine casing 2 or the end plates 32a, 32b.

Aspects of the present invention have been described by way of example only and it should be appreciated that modifications and additions may be made thereto without departing from the scope thereof, as defined in the appended claims.

1. A two-stroke engine including:
an engine block having a cylinder;
a double-ended piston received for reciprocation in the cylinder, the piston comprising a body having first and second opposing ends, the first end forming a wall of the combustion chamber, the second end forming a wall of a pre-compression chamber, the piston including a piston opening between the first and second ends;
at least one passage extending from the pre-compression chamber to the combustion chamber for charging the combustion chamber;
a connecting rod operatively connecting the piston to a crankshaft, and characterised in that:
the piston opening encloses the connecting rod and the crankshaft protrudes through the piston opening.

2. An engine as claimed in claim 1, wherein said piston opening extends between opposing mouth portions in the sides of the piston and said crankshaft is orientated to protrude through both opposing mouth portions.

3. An engine as claimed in claim 1, wherein the piston opening is sealed, with a piston opening seal extending around each of the mouth portions for engagement with the cylinder wall.

4. An engine as claimed in claim 1, wherein the piston opening forms a sealed crankcase, capable of being filled with oil for lubrication of engine components enclosed therein.

5. An engine as claimed in claim 1 wherein the piston is configured with substantially arcuate or cylindrical lateral faces.

6. An engine as claimed in claim 1, wherein the cylinder is non-cylindrical and the mouth portions are formed in opposing lateral faces which are substantially planar and parallel with the axis of reciprocation of the piston.

7. An engine as claimed in claim 1, wherein the piston is formed from an extruded section with the two flat faces extending generally perpendicular to the axis of the extrusion.

8. An engine as claimed in claim 1, wherein the piston has four substantially planar lateral faces.

9. An engine as claimed in claim 1, wherein the engine block is formed from an extruded section.

10. A piston seal assembly for sealing between a piston and a cylinder wall, the side surfaces of the piston having first and second piston faces meeting at an intersection, the cylinder wall having corresponding first and second cylinder wall faces, the seal assembly including:
first and second seal portions adapted to be received in a groove in the piston for engagement with the first and second cylinder wall faces respectively, adjacent ends of the seal portions being aligned generally with the intersection,
a seal wedge adapted to be received in the groove between the adjacent ends of the seal portions for abutting cooperating end faces of the adjacent ends, and
resilient means for biasing the seal wedge outward toward the cylinder wall, thereby pressing the first and second seal portions against the cylinder wall.

11. A piston seal assembly as claimed in claim 10, wherein said resilient means is at least one spring.

12. A piston seal assembly as claimed in claim 10, wherein said piston is provided with four substantially planar lateral faces with four seal portions, each engaging a separate side of the cylinder wall, with four seal wedges—one at the intersection of each seal portion.

13. A piston seal assembly as claimed in claim 10, wherein said groove is annular and a substantially annular spring is received in the groove and acts upon each of the seal wedges.

14. A piston seal assembly as claimed in claim 10, wherein a said seal assembly is received in a circumferential groove in the piston adjacent the first end.

15. A piston seal assembly as claimed in claim 14, wherein a further said seal assembly is received in a circumferential groove in the piston adjacent the second end.

16. A piston seal assembly as claimed in claim 10, wherein the shape of the second end of the piston substantially conforms to the opposing wall of the pre-compression chamber.

17. A piston machine, including:
a block having a cylinder;
a double-ended piston received for reciprocation in the cylinder, the piston comprising a body having first and second opposing ends forming walls of respective chambers, the piston including a piston opening between the first and second ends;
a connecting rod operatively connecting the piston to a crankshaft, and characterised in that
the piston opening encloses the connecting rod and the piston opening extends between opposing mouth portions in the sides of the piston, the crankshaft protruding through both mouth portions, with a seal extending around each of the mouth portions for engagement with the cylinder wall.

18-21. (canceled)
